(19) United States
(12) Patent Application Publication
(10) Pub. No.: US 2016/0105693 A1
(43) Pub. Date: Apr. 14, 2016

(54) Digital transmission only over cable TV

(71) Applicant: Michael Lewis Moravitz, Fairfax, VA (US)

(72) Inventor: Michael Lewis Moravitz, Fairfax, VA (US)

(21) Appl. No.: 14/121,693

(22) Filed: Oct. 9, 2014

(51) Int. Cl. H04N 21/238; H04N 21/61

(52) U.S. Cl. CPC H04N 21/238; H04N 21/6118

(57) ABSTRACT

High-speed Cable TV Providers Should Modify Their Channel Lineups to Avoid Duplicating Channels in Both Analog and Digital.

Analog televisions can receive both digital and analog transmissions and digital looks better than analog.

Cable television does not need to feed both analog and digital transmissions of the same channel: only the digital is necessary, since it will be better whether the television is digital or analog. Satellite television providers such as Direct TV have done this, but FIOS has not and perhaps other cable television providers with digital feeds. This will simply the channel lineup, making it markedly easier for cable TV subscribers to find their favorite programs and would probably reduce costs for cable TV corporations.

1) Builds on Patents for High-speed Cable,

2) Analog TV Signals

3) Digital TV Signals.
